(19) United States
(12) Patent Application Publication
(10) Pub. No.: US 2007/0133365 A1
(43) Pub. Date: Jun. 14, 2007

(54) TILT CALIBRATION APPARATUS AND METHOD CAPABLE OF ADJUSTING INCLUDED ANGLE BETWEEN OPTICAL PICK-UP HEAD AND OPTICAL DISC ACCORDING TO WOBBLE SIGNAL

(76) Inventors: Shih-Hao Ko, Tai-Chung Hsien (TW); Chi-Jui Lee, Tao-Yuan City (TW); Ying-Feng Huang, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,962

(22) Filed: Dec. 12, 2005

(51) Int. Cl. G11B 7/00

(52) U.S. Cl. 369/44.32; 369/53.19

(57) ABSTRACT

A tilt calibrating apparatus and method capable of adjusting an included angle between an optical disc and an optical pick-up head are disclosed. The tilt calibrating apparatus includes a photo detector, in the optical pick-up head, for detecting a signal reflected from a wobble groove on the optical disc, a wobble processor, electrically connected to the photo detector, for generating a wobble signal according to the signal reflected from a wobble groove on the optical disc, and an driver, electrically connected to the wobble processor, for controlling the included angle by rotating the optical pick-up head or the optical disc according to the wobble signal.

### BACKGROUND

The present invention relates to a controlling apparatus and method of an optical disc drive, and more particularly, to a tilt calibration apparatus and method capable of adjusting an angle between an optical pick-up head and an optical disc according to a wobble signal.

For several years, optical disc drives have been considered standard equipment for personal computers. Generally, optical disc drives read information stored on optical discs. Examples of related art optical disc drives are known as compact disc drives (CD-ROM drives) and digital versatile disc drives (DVD-ROM drives). Some optical disc drives, CD-RW and DVD-RW, for example, have additional capability for rewriting data on optical discs.

Optical disc drives are utilized in the playback and storage of many varieties of digital media including: music, video, images, data archives, software, and games. The optical pick-up head reads data stored on the optical disc by first emitting a laser beam and then utilizing its reflected laser beam from the optical disc. The optical pick-up head can also emit a laser beam to etch/heat the optical disc, so as to record data onto the optical disc. In an optimum condition, the laser beam is vertically emitted to the optical disc by the optical pick-up head. Unfortunately, the quality of recorded data or the quality of read data becomes worse, when the optical pick-up head tilts.

Please refer to FIG. 1, which is a schematic diagram of the related art optical disc drive 10. The optical disc drive 10 comprises a spindle 12 and an optical pick-up head 14. The spindle 12 is utilized to rotate an optical disc 20 under a constant linear velocity (CLV) mode or a constant angular velocity (CAV) mode, and the optical pick-up head 14 is utilized to emit an incident laser beam 22 and received a reflected laser beam 24 during a reading process or a recording process. As shown in FIG. 1, there is an included angle θ between the optical disc 20 and the optical pick-up head 14 and an included angle φ between the incident laser beam 22 and the optical pick-up head 14. In the optimum condition, the included angle θ between the optical disc 20 and the optical pick-up head 14 is zero degrees, and the included angle φ between the incident laser beam 22 and the optical pick-up head 14 corresponds to 90 degrees (i.e., the optical disc 20 and the optical pick-up head 14 are parallel to each other). However, when the optical pick-up head 14 tilts, the power of the incident laser beam 22 for illuminating the optical disc 20 disperses because the area of the spot illuminated by incident laser beam 22 is greater than the area of the spot illuminated by a vertically incident laser beam. Consequently, the quality of read data corresponding to the reflected laser beam 24 is deteriorated. In the same way, when the optical disc drive 10 is utilized to record data onto the optical disc 20, the quality of recorded data is deteriorated because the power of the incident laser beam 22 for etching/heating the optical disc 20 also disperses due to tilt of the optical pick-up head 14.

As a result, tilt calibration is an important issue for optical disc drive systems. A conventional method for solving the above-mention problem is to control the included angle θ between the optical disc 20 and the optical pick-up head 14 according to the recorded data on the optical disc 20. The conventional method first utilizes the optical pick-up head 14 to read the data recorded on the optical disc, then adjusts the included angle θ between the optical disc 20 and the optical pick-up head 14 until the error rate of the recorded data is below an acceptable value. Additionally, the conventional method is capable of adjusting the included angle θ according to jitter or other characteristics associated with the recorded data. However, the conventional method mentioned above cannot adjust the included angle θ if the optical disc 20 is blank. In other words, the above-mentioned conventional method can only be applied to calibrating tilt of the optical pick-up head 14 through information provided by the recorded data read from the optical disc 20. The above-mentioned conventional method is unable to work properly when the optical disc drive is utilized to record data onto a blank optical disc 20.

### SUMMARY

It is therefore one of the objectives of the claimed invention to provide a tilt calibrating apparatus and a related method to solve the above-mentioned problem.

According to the claimed invention, a tilt calibrating apparatus for adjusting an included angle between an optical disc and an optical pick-up head is disclosed. The tilt calibrating apparatus comprises a photo detector, in the optical pick-up head, for detecting a signal reflected from a wobble groove on the optical disc; a wobble processor, electrically connected to the photo detector, for generating a wobble signal according to the signal reflected from a wobble groove; and an driver, electrically connected to the wobble processor for controlling the included angle by rotating the optical pick-up head according to the wobble signal.

According to the claimed invention, a tilt calibrating method for adjusting an included angle between an optical disc and an optical pick-up head is disclosed. The tilt calibrating method comprises detecting a signal reflected from a wobble groove on the optical disc; generating a wobble signal according to the signal reflected from a wobble groove on the optical disc; and controlling the included angle according to the wobble signal.

The tilt calibrating apparatus and the related method according to the present invention utilize the wobble signal to adjust the included angle between the optical disc and the optical pick-up head. Because the wobble groove for generating the wobble signal exists on any recordable optical discs, the tilt calibrating apparatus and method can be utilized by the optical disc drive when the optical disc drive is recording data onto a recordable optical disc or when the optical disc drive is reading the recorded data from the optical disc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a related art optical disc drive.

FIG. 2 is a flow chart of a tilt calibrating method according to a first embodiment of the present invention.

FIG. 3 is a bottom view of an optical disc and an optical pick-up head.

FIG. 4 is a flow chart of a tilt calibrating method according to a second embodiment of the present invention.

FIG. 5 is a partially enlarged view of the optical disc shown in FIG. 5.

FIG. 6 is a flow chart of a tilt calibrating method according to a third embodiment of the present invention.

FIG. 7 is a schematic diagram of a tilt calibrating apparatus according to an embodiment of the present invention.

### DETAILED DESCRIPTION

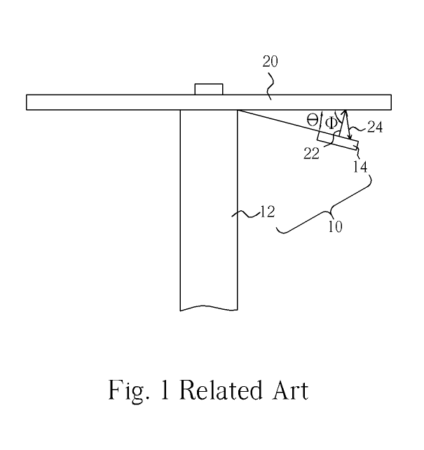

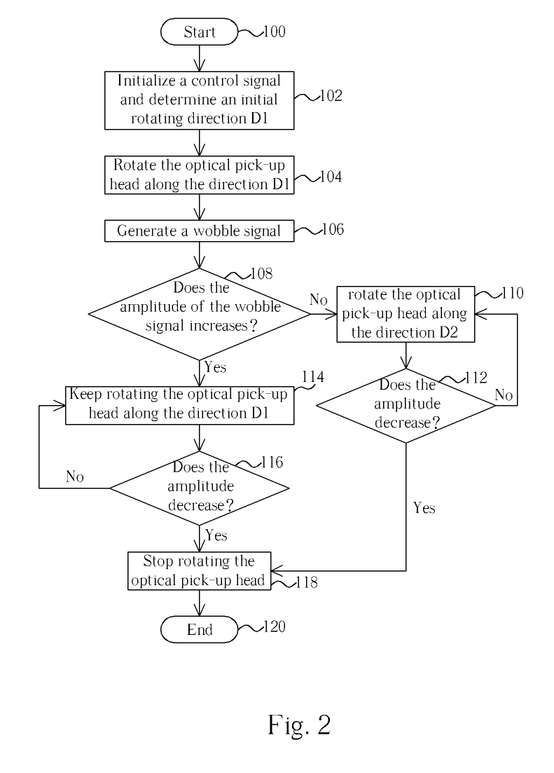

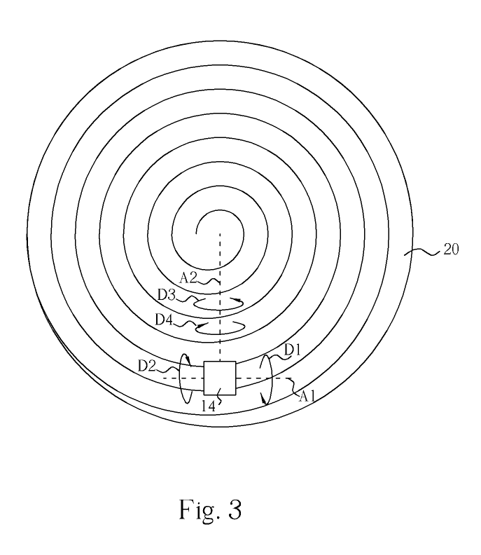

Please refer to FIG. 2 and FIG. 3. FIG. 2 is a flow chart of a tilt calibrating method according to a first embodiment of the present invention. FIG. 3 is a bottom view of the optical disc 20 and the optical pick-up head 14 shown in FIG. 1. As shown in FIG. 3, the optical pick-up head 14 pivots on an axis A1, which is vertical to a radial direction of the optical disc 20 and along a direction D1 or a direction D2 according to the present embodiment. The operation of the first embodiment is described as follows:

Step 100: Start.

Step 102: Initialize a control signal and determine an initial rotating direction D1.

Step 104: Rotate the optical pick-up head 14 along the direction D1.

Step 106: Detect a signal reflected from a wobble groove of the optical disc 20, and then generate a wobble signal according to the signal reflected from the wobble groove.

Step 108: If it is determined that the amplitude of the wobble signal increases, then proceed to step 114; otherwise, proceed to step 110.

Step 110: Update the control signal to rotate the optical pick-up head 14 along the direction D2.

Step 112: If it is determined that the amplitude of the wobble signal decreases, then proceed to step 118; otherwise, proceed to step 110.

Step 114: Update the control signal to keep rotating the optical pick-up head 14 along the direction D1.

Step 116: If it is determined that the amplitude of the wobble signal decreases, then proceed to step 118; otherwise, proceed to step 114.

Step 118: Stop rotating the optical pick-up head 14.

Step 120: End.

To begin, the tilt calibrating method initialized a control signal utilized for controlling the rotation of the optical pick-up head 14, and determines an initial rotating direction D1. Assume the value of the initial control signal is “0”. If the value of the control signal increases to be “1”, the pick-up head 14 is driven to rotate along the direction D1 with 1 degree. In the same manner, if the value of the control signal is decreases to be “−1”, the pick-up head 14 is driven to rotate along the direction D2 with 1 degree. In this embodiment, the direction D1 is selected to act as the initial rotating direction. Please note that the other direction D2, depending on the design requirement, is allowed to be the initial direction. As known to those skilled in this art, if the direction D2 is the initial direction, the corresponding flow chart can be easily concluded through modifying the flow chart shown in FIG. 2.

If the amplitude of the wobble signal increases, which means that the optical pick-up head 14 is rotated in a correct direction, the included angle between the optical pick-up head 14 and the optical disc 20 decreases accordingly. Therefore, the tilt calibrating method updates the control signal to keep the optical pick-up head 14 rotating in the currently selected direction D1. On the contrary, if the amplitude of the wobble signal decreases, which means that the optical pick-up head 14 is rotated in a wrong initial direction (the direction D1), the included angle between the optical pick-up head 14 and the optical disc 20 is increased accordingly. Therefore, the tilt calibrating method updates the control signal to rotate the optical pick-up head 14 along the other direction D2.

After a correct direction is adopted, the included angle between the optical pick-up head 14 and the optical disc 20 continually decreases. Ultimately the tilt calibrating method stops rotating the optical pick-up head 14 along the correct direction at the time the magnitude of the wobble signal starting to decrease. After the tilt calibrating method is executed, the included angle between the optical pick-up head 14 and the optical disc 20 is about zero degrees. In other words, the optical pick-up head 14 and the optical disc 20 are substantially parallel to one other.

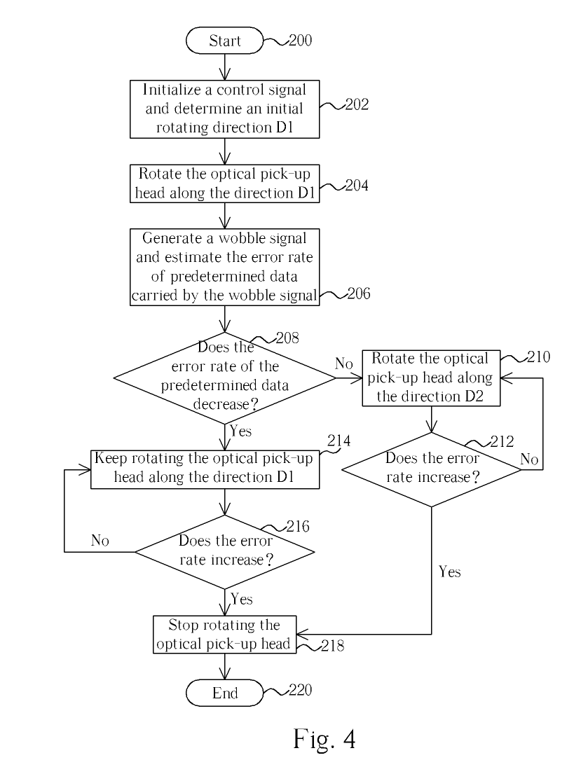

Please refer to FIG. 4 and FIG. 3. FIG. 4 is a flow chart of the tilt calibrating method according to a second embodiment of the present invention for rotating the optical pick-up head 14 according to the same axis A1. It is well known that the wobble signal carries some predetermined data providing information, such as ADIP (Address in pre-groove) address information and PPIT (Pre-pit) address information, of the optical disc. In this embodiment, the tilt calibrating method utilizes the predetermined data by rotating the optical pick-up head 14 according to an error rate of the predetermined data carried by the wobble signal. The steps of the tilt calibrating method are:

Step 200: Start.

Step 202: Initialize a control signal and determine a corresponding to the direction D1.

Step 204: Rotate the optical pick-up head 14 along the direction D1.

Step 206: Detect a signal reflected from a wobble groove on the optical disc 20, generate a wobble signal according to the signal reflected from a wobble groove, and estimate the error rate of the predetermined data carried by the wobble signal.

Step 208: If it is determined that the error rate of the predetermined data decreases, then proceed to step 214; otherwise, proceed to step 210.

Step 210: Update the control signal to rotate the optical pick-up head 14 along the direction D2.

Step 212: If it is determined that the error rate of the predetermined data increases, then proceed to step 218; otherwise, proceed to step 210.

Step 214: Update the control signal to keep rotating the optical pick-up head 14 along the direction D1.

Step 216: If it is determined that the error rate of the predetermined data increases, then proceed to step 218; otherwise, proceed to step 214.

Step 218: Stop rotating the optical pick-up head 14.

Step 220: End.

To begin, the tilt calibrating method initializes a control signal utilized for controlling the rotation of the optical pick-up head 14, and determines an initial rotating direction D1. The utilization of the control signal is explained in the above paragraphs, so the repeated description is omitted. In this embodiment, the direction D1 is selected as the initial direction. Similarly, depending on the design requirement, direction D2 can be selected as the initial direction. As known to those skilled in this art, if the direction D2 is the initial direction, the corresponding flow chart can be easily concluded through modifying the flow chart shown in FIG. 4.

After the optical pick-up head 14 begins rotating along the initial direction (the direction D1), the error rate of the predetermined data carried by the wobble signal is estimated. If the error rate of the predetermined data decreases, which means that the included angle between the optical pick-up head 14 and the optical disc 20 decreases, then the tilt calibrating method updates the control signal to continue rotating the optical pick-up head 14 along the selected direction D1. On the contrary, if the error rate of the predetermined data increases, which means that the included angle between the optical pick-up head 14 and the optical disc 20 increases, the tilt calibrating method updates the control signal to rotate the optical pick-up head 14 along the other direction D2. The included angle between the optical pick-up head 14 and the optical disc 20 continue decreasing when the optical pick-up head 14 is rotated along the correct direction. However, the tilt calibrating method stops rotating the optical pick-up head 14 at the time the error rate of the predetermined data starting to increase. After the tilt calibrating method is executed, the included angle between the optical pick-up head 14 and the optical disc 20 is about zero degrees. In other words, the optical pick-up head 14 and the optical disc 20 are substantially parallel to one other.

It should be noted that the direction that the pick-up head 14 rotates along is not limited to D1 and D2 according to the present invention. In other words, the pick-up head 14 is capable of pivoting another axis, such as the axis A2 parallel to the radial direction of the optical disc 20 shown in FIG. 3, to rotate. Additionally, the tilt calibrating method is not limited to utilizing the error rate as an index for indicating which direction is correct and when to stop the calibration. The tilt calibrating method can utilize the jitter or other characteristics of the predetermined data to adjust the control signal to control the included angle between the optical pick-up head 14 and the optical disc 20.

In a third embodiment, the optical pick-up head 14 also pivots on an axis A1 along a direction D1 or a direction D2. However, the method of selecting the rotating direction in the third embodiment is different from the first and the second embodiments. In the third embodiment, the rotating direction is selected from the directions D1 and D2 according to an inner wobble signal and an outer wobble signal.

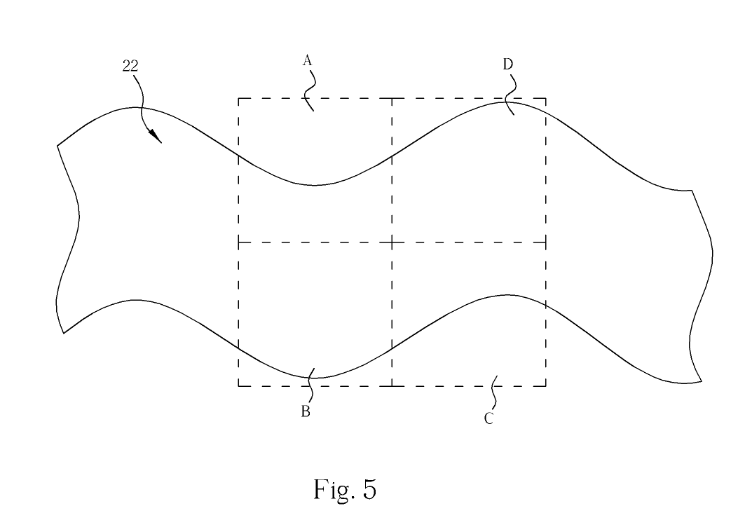

For explaining the operation of the third embodiment, please refer to FIG. 5. FIG. 5 is a partially enlarged view of the optical disc 20 below the optical pick-up head 14. The enlarged part of the optical disc 20 comprises a wobble groove 22 and four areas A, B, C, and D detected by four well-known sensors in the optical pick-up head 14. The incident laser beam generated by the optical pick-up head 14 is emitted onto these four areas A, B, C, and D, so as to generate four wobble signals according to reflected laser beam coming from these four areas A, B, C, and D, respectively. Please note that areas A and D are closer to the center of the optical disc 20 than areas B and C. Therefore, the inner wobble signal mentioned above is defined to be a sum of the wobble signals corresponding to the areas A and D, and the outer wobble signal mentioned above is defined to be a sum of the other two wobble signals corresponding to the areas B and C. Although in the third embodiment the optical pick-up head 14 pivots on an axis A1, the optical pick-up head 14 is capable of pivoting on any other axes parallel with the plane of the optical disc 20 in the present invention. For example, if the optical pick-up head 14 pivots on an axis A2 shown in FIG. 3 along a direction D3 or a direction D4, a rotating direction is selected from the directions D3 and D4 according to a right wobble signal and a left wobble signal, where the right wobble signal is defined to be a sum of two wobble signals reflected from the areas C and D and the left wobble signal is defined to be a sum of two wobble signals reflected from the areas A and B.

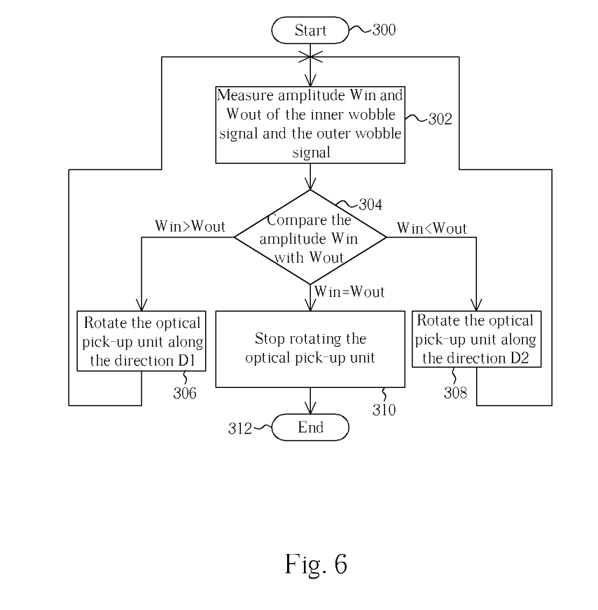

Please refer to FIG. 6 in conjunction with FIG. 3. FIG. 6 is a flow chart of the tilt calibrating method according to the third embodiment of the present invention. The process of the tilt calibrating method according to the present embodiment are shown in the following steps:

Step 300: Start.

Step 302: Measure amplitude Wᵢₙ, Wₒᵤₜ of the inner wobble signal and the outer wobble signal.

Step 304: Compare the amplitude Wᵢₙ of the inner wobble signal with the amplitude Wₒᵤₜ of the outer wobble signal. If the amplitude Wᵢₙ is greater than the amplitude Wₒᵤₜ, proceed to step 306; if the amplitude Wᵢₙ is less than the amplitude Wₒᵤₜ, proceed to step 308; or if the amplitude Wᵢₙ is equal to the amplitude Wₒᵤₜ, proceed to step 310.

Step 306: Rotate the optical pick-up head 14 along the direction D1, then proceed to step 302.

Step 308: Rotate the optical pick-up head 14 along the direction D2, then proceed to step 302.

Step 310: Stop rotating the optical pick-up head 14.

Step 312: End.

The tilt calibrating method separates the optical pick-up head 14 into an inner side and an outer side according to the third embodiment. The inner side is utilized to detect the inner wobble signal, while the outer side is utilized to detect the outer wobble signal. Referring to FIG. 6, it is obvious that when the amplitude Wᵢₙ of the inner wobble signal is greater than the amplitude Wₒᵤₜ of the outer wobble signal, the distance between the inner side of the optical pick-up head 14 and the optical disc 20 is sure to be shorter than the distance between the outer side of the optical pick-up head 14 and the optical disc 20 (i.e., the inner side of the optical pick-up head 14 is tilted to the optical disc 20). However, when the amplitude Wᵢₙ of the inner wobble signal is less than the amplitude Wₒᵤₜ of the outer wobble signal, the distance between the inner side of the optical pick-up head 14 and the optical disc 20 is sure to be longer than the distance between the outer side of the optical pick-up head 14 and the optical disc 20 (i.e., the outer side of the optical pick-up head 14 is tilted to the optical disc 20). Therefore, if the amplitude Wᵢₙ is found greater than the amplitude Wₒᵤₜ, the tilt calibrating method rotates the optical pick-up head 14 along the direction D1 making the outer side of the optical pick-up head 14 approach the optical disc 20; on the contrary, if the amplitude Wᵢₙ is found less than the amplitude Wₒᵤₜ, the tilt calibrating method rotates the optical pick-up head 14 along the direction D2 making the inner side of the optical pick-up head 14 approach the optical disc 20. The tilt calibrating method stops rotating the optical pick-up head 14 at the time the amplitude Wᵢₙ of the inner wobble is equal to the amplitude Wₒᵤₜ of the outer wobble. Finally, the tilt calibrating method is completed.

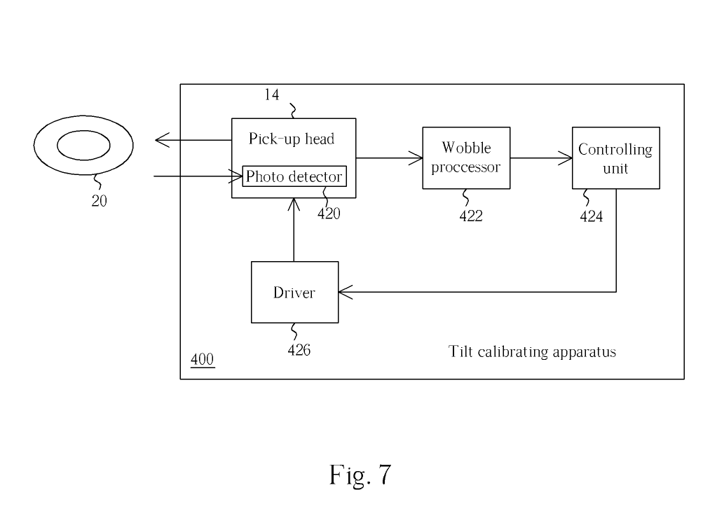

Please refer to FIG. 7. FIG. 7 is a schematic diagram of a tilt calibrating apparatus 400 according to an embodiment of the present invention. The tilt calibrating apparatus 400 is capable of implementing the above-mentioned tilt calibrating method, and comprises a photo detector 420, a wobble processor 422, a controlling unit 424, and a driver 426. The photo detector 420 in the optical pick-up head 14 is utilized for detecting a signal reflected from a wobble groove on the optical disc. The wobble processor 422 generates the wobble signal, or the inner and the outer wobble signals according to the signal reflected from the wobble groove on the optical disc 20. The controlling unit 424 is utilized for determining the above-mentioned control signal to control the driver 426, and for updating the control signal according to the wobble signal, or the inner and outer wobble signals. Then, the driver 426 rotates the optical pick-up head 14 of the optical disc drive in order to adjust the included angle between the optical disc 20 and the optical pick-up head 14.

Please note that, in the above embodiments, the tilt calibrating method and the tilt calibrating apparatus rotate the optical pick-up head 14 to adjust the location relationship between the optical disc 20 and the optical pick-up head 14. However, as known to those skilled in the art, calibrating tilt of the optical disc 20 while the optical pick-up head 14 remains fixed is equivalent to calibrating tilt of the optical pick-up head 14 while the optical disc 20 remains fixed. In other words, the tilt calibrating method and the tilt calibrating apparatus are capable of being applied to calibrating tilt of the optical disc 20 with the optical pick-up head 14 fixed in place. For example, the spindle 12 shown in FIG. 1 is rotated for controlling the included angle between the optical disc 20 and the optical pick-up head 14. The same objective of calibrating the location relationship between the optical disc 20 and the optical pick-up head 14 is achieved resulting in better data quality of recording operation and reading operation.

In contrast to the related art, the tilt calibrating apparatus and method of the present invention utilize the wobble signal to adjust the included angle between the optical disc and the optical pick-up head. As a result, the calibrating apparatus and related method of the present invention can be utilized by the optical disc drive during the optical disc drive recording or the optical disc drive reading operations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tilt calibrating apparatus for adjusting an included angle between an optical disc and an optical pick-up head, the tilt calibrating apparatus comprising:
a photo detector, in the optical pick-up head, for detecting a signal reflected from a wobble groove on the optical disc;
a wobble processor, electrically connected to the photo detector, for generating a wobble signal according to the signal reflected from the wobble groove; and
an driver, electrically connected to the wobble processor, for controlling the included angle by rotating the optical pick-up head or the optical disc according to the wobble signal.

2. The tilt calibrating apparatus of claim 1, further comprising:
a controlling unit, electrically connected between the wobble processor and the driver, for generating a control signal according to the wobble signal to control the driver;
wherein the driver rotates the optical pick-up head according to the control signal in order to decreases the included angle between the optical disc and the optical pick-up head.

3. The tilt calibrating apparatus of claim 2, wherein the driver rotates the optical pick-up head until the amplitude of the wobble signal is substantially maximum.

4. The tilt calibrating apparatus of claim 3, wherein if the amplitude of the wobble signal is increased after the driver rotates the optical pick-up head along a first direction according to a control signal, the controlling unit outputs the control signal to control the driver to keep rotating the optical pick-up head along the first direction; and if the amplitude of the wobble signal is decreased after the driver rotates the optical pick-up head along the first direction, the controlling unit outputs the control signal to stop the driver from rotating the optical pick-up head.

5. The tilt calibrating apparatus of claim 4, wherein if the amplitude of the wobble signal is decreased after the driver rotates the optical pick-up head along the first direction according to the control signal, the controlling unit outputs the control signal to control the driver to rotate the optical pick-up head along a second direction opposite to the first direction; and if the amplitude of the wobble signal is decreased after the driver rotates the optical pick-up head along the second direction, the controlling unit outputs the control signal to stop the driver from rotating the optical pick-up head.

6. The tilt calibrating apparatus of claim 3, wherein the wobble signal carries a predetermined data.

7. The tilt calibration apparatus of claim 6, wherein if the error rate of the predetermined data is decreased after the driver rotates the optical pick-up head along a first direction according to a control signal, the controlling unit outputs the control signal to control the driver to continue rotating the optical pick-up head along the first direction; and if the error rate of the predetermined data is increased after the driver rotates the optical pick-up head along the first direction, the controlling unit outputs the control signal to stop the driver from rotating the optical pick-up head.

8. The tilt calibration apparatus of claim 6, wherein if the error rate of the predetermined data is increased after the driver rotates the optical pick-up head along the first direction according to the control signal, the controlling unit outputs the control signal to control the driver to rotate the optical pick-up head along a second direction opposite to the first direction; and if the error rate of the predetermined data is increased after the driver rotates the optical pick-up head along the second direction, the controlling unit outputs the control signal to stop the driver from rotating the optical pick-up head.

9. The tilt calibrating apparatus of claim 2, wherein the controlling unit generates the control signal according to an inner wobble signal and an outer wobble signal generated from the wobble processor, the inner wobble signal corresponds to an inner side of the optical pick-up head, the outer wobble signal corresponds an outer side of the pick-up head, the controlling unit outputs the control signal to drive the driver to rotate the optical pick-up head to make the inner side approach the optical disc when the amplitude of the inner wobble signal is less than the amplitude of the outer wobble signal, and the controlling unit outputs the control signal to drive the driver to rotate the optical pick-up head to make the outer side approach the optical disc when the amplitude of the inner wobble signal is greater than the amplitude of the outer wobble signal.

10. A tilt calibrating method for adjusting an included angle between an optical disc and an optical pick-up head, the tilt calibrating method comprising:
detecting a signal reflected from a wobble groove on the optical disc;
generating a wobble signal according to the signal reflected from the wobble groove; and
controlling the included angle by rotating the optical disc or the optical pick-up head according to the wobble signal.

11. The tilt calibrating method of claim 10, further comprising:
generating a control signal according to the wobble signal; and
the step of controlling the included angle comprising:
rotating the optical pick-up head according to the control signal to adjust the included angle.

12. The tilt calibrating method of claim 11, wherein the step of rotating the optical pick-up head comprises:
rotating the optical pick-up head according to an axis parallel to a radial direction of the optical disc until the amplitude of the wobble signal is substantially maximum.

13. The tilt calibrating method of claim 12, wherein the step of generating the control signal comprises:
if the amplitude of the wobble signal increases after rotating the optical pick-up head along a first direction according to a control signal, updating the control signal to keep rotating the optical pick-up head along the first direction; and
if the amplitude of the wobble signal decreases after rotating the optical pick-up head along the first direction, updating the control signal to stop rotating the optical pick-up head.

14. The tilt calibrating method of claim 13, wherein the step of generating the control signal further comprises:
if the amplitude of the wobble signal decreases after rotating the optical pick-up head along the first direction according to the control signal, updating the control signal to rotate the optical pick-up head along a second direction opposite to the first direction; and
if the amplitude of the wobble signal decreases after rotating the optical pick-up head along the second direction, updating the control signal to stop rotating the optical pick-up head.

15. The tilt calibrating apparatus of claim 12, wherein the wobble signal carries a predetermined data.

16. The tilt calibrating method of claim 15, wherein the step of generating the control signal comprises:
if the error rate of the wobble signal decreases after rotating the optical pick-up head along a first direction according to a control signal, updating the control signal to keep rotating the optical pick-up head along the first direction; and
if the error rate of the wobble signal increases after rotating the optical pick-up head along the first direction, updating the control signal to stop rotating the optical pick-up head.

17. The tilt calibrating method of claim 16, wherein the step of generating the control signal further comprises:
if the error rate of the wobble signal increases after the rotating the optical pick-up head along the first direction according to the control signal, updating the control signal to rotate the optical pick-up head along a second direction opposite to the first direction; and
if the error rate of the wobble signal increases after the rotating the optical pick-up head along the second direction, outputting the control signal to stop rotating the optical pick-up head.

18. The tilt calibrating method of claim 11, wherein the step of generating the control signal comprises:
generating the control signal according to an inner wobble signal and an outer wobble signal according to the signal reflected from the wobble groove, the inner wobble signal corresponds to an inner side of the optical pick-up head, the outer wobble signal corresponds an outer side of the pick-up head.

19. The tilt calibrating method of claim 18, wherein the step of generating the control signal further comprises:
updating the control signal corresponding to rotating the optical pick-up head to make the inner side approach the optical disc when the amplitude of the inner wobble signal is less than the amplitude of the outer wobble signal; and
updating the control signal corresponding to rotating the optical pick-up head to make the outer side approach the optical disc when the amplitude of the inner wobble signal is greater than the amplitude of the outer wobble signal.
